(19) United States
(12) Patent Application Publication
(10) Pub. No.: US 2021/0365253 A1
(43) Pub. Date: Nov. 25, 2021

(54) HETEROGENEITY-AGNOSTIC AND TOPOLOGY-AGNOSTIC DATA PLANE PROGRAMMING

(71) Applicant: Alibaba Group Holding Limited, Grand Cayman (KY)

(72) Inventors: Ennan Zhai, Seattle, WA (US); Hongqiang Liu, Seattle, WA (US)

(21) Appl. No.: 16/881,915

(22) Filed: May 22, 2020

(51) Int. Cl. G06F 8/41; G06F 8/51; G06F 16/31

(52) U.S. Cl. CPC G06F 8/443; G06F 8/433; G06F 16/322; G06F 8/447; G06F 8/51; G06F 8/437

(57) ABSTRACT

The present disclosure provides a compiler operative to convert computer-executable instructions for a network data plane written in a heterogeneity-agnostic and topology-agnostic programming language into an intermediate representation, then compile the intermediate representation into multiple executable representations according to topological constraints of the network. Users may develop software-defined network functionality for a data center network composed of heterogeneous network devices by writing code in a programming language implementing heterogeneity-agnostic and topology-agnostic abstractions, while the compiler synthesizes heterogeneity-dependent and topology-dependent computer-executable object code implementing the software-defined network functionality across network devices of the data center network by analyzing logical dependencies and network topology to determine dependency constraints and resource constraints.

### BACKGROUND

Programmable networks are an emerging development in the field of network engineering. Computer networks are established by specialized hardware devices each developed to perform specific roles in transmission of data over networks. For example, devices such as routers and switches interconnect network devices by performing algorithmic functions such as packet forwarding. The earliest of these devices were pre-programmed and designed at the hardware level to operate by logic as contemplated by manufacturers and vendors, with settings configurable by users to some limited extent. Being special-purpose hardware, such physical network devices were fixed in functionality and could not be easily re-programmed, resulting in devices being custom-engineered for particular network applications at significant expense.

Over time, network devices such as switches transitioned to general-purpose processors, which may be programmed using machine code or low-level programming languages, as well as special-purpose chips, usually application specific integrated circuits (“ASICs”), which may be programmed using hardware description languages. Consequently, though the costs of hardware customization are alleviated to some extent, in their place network engineers incur high learning costs to gain the skillsets necessary to support network hardware from a variety of vendors.

Data centers are an example of a cost-intensive network application in terms of network device requirements. Data centers commonly house numerous servers and computer systems for supporting network-reliant critical business operations, requiring specific functional specifications for metrics such as availability, redundancy, power management, security, and the like. Frequently, data center networks aggregate hardware devices from a variety of vendors to facilitate design of their desired function. Whether utilizing customized, fixed-function network hardware or conventionally programmable network hardware as building blocks of a data center's network architecture, specifics of data center requirements on network hardware are generally costly to satisfy due to functionality customization still being greatly hardware-bound and device architecture-bound.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architectural diagram of an architecture of an example data center network according to example embodiments of the present disclosure.

FIG. 2 illustrates a logical diagram of an architecture of the example data center network according to example embodiments of the present disclosure.

FIG. 3 illustrates a schematic architecture of a compiler according to example embodiments of the present disclosure.

FIGS. 4A and 4B illustrate a flowchart of a compilation method according to example embodiments of the present disclosure.

FIG. 5A illustrates a flowchart illustrating code linearization according to example embodiments of the present disclosure. FIG. 5B illustrates a partial tree including nodes and edges as constructed based on FIG. 5A.

FIG. 6 illustrates a system architecture of a network hardware system according to example embodiments of the present disclosure.

FIG. 7 illustrates an example computing system for implementing the processes and methods described above for implementing compilation.

### DETAILED DESCRIPTION

Systems and methods discussed herein are directed to implementing a programming language compiler, and more specifically implementing a compiler operative to convert computer-executable instructions for a network data plane written in a heterogeneity-agnostic and topology-agnostic programming language into an intermediate representation, then compile the intermediate representation into multiple executable representations according to topological constraints of the network.

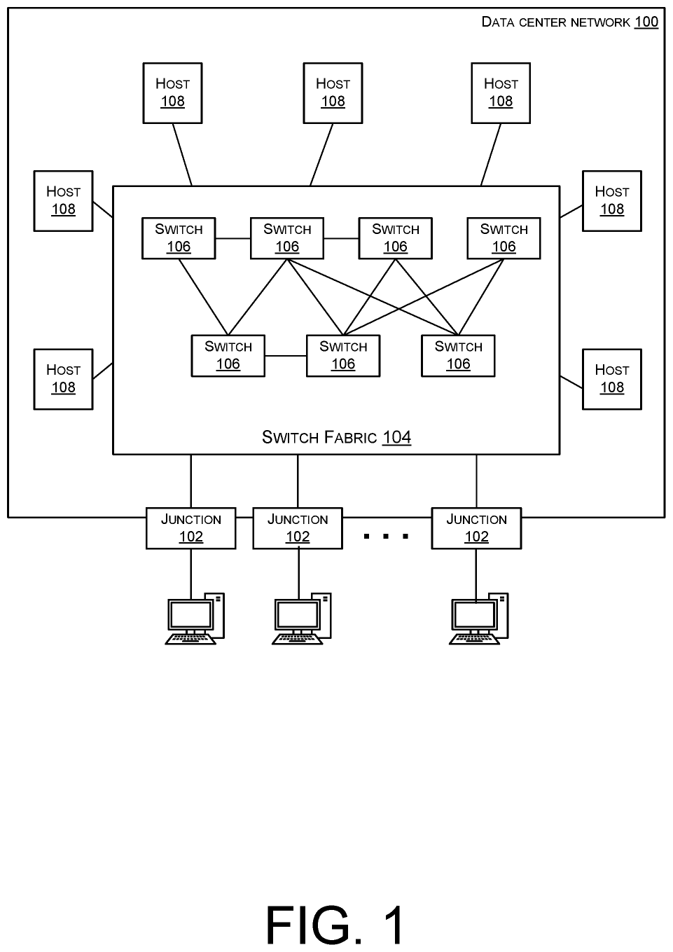

FIG. 1 illustrates an architectural diagram of an architecture 100 of an example data center network 100 according to example embodiments of the present disclosure.

Computer networks established in a data center interconnect computing resources such as physical and/or virtual processors, memory, storage, computer-executable applications, computer-readable data, and the like. A data center network 100 may receive inbound traffic from external hosts originating from outside networks, such as personal area networks (“PANs”), wired and wireless local area networks (“LANs”), wired and wireless wide area networks (“WANs”), the Internet, and so forth, through junctions 102 such as gateways, firewalls, and the like. Inbound traffic may take the form of packets formatted and encapsulated according to any combination of a variety of network communication protocols which may interoperate, such as Internet Protocol (“IP”) and Transmission Control Protocol (“TCP”); virtualized network communication protocols such as Virtual Extensible LAN (“VxLAN”); routing protocols such as Multiprotocol Label Switching (“MPLS”); and the like.

Packets received in a data center network 100 may be passed from junctions 102 to a switch fabric 104 of the data center network 100. A switch fabric 104 generally refers to a component of a network architecture wherein a collection of some number of network switches 106(1), 106(2), . . . 106(N) (where any unspecified switch may be referred to as a switch 106) interconnected by network connections. Any number of hosts 108 of the data center network 100 may connect to any number of arbitrary switches 106 of the switch fabric 104. Switches 106 of the switch fabric 104 may serve to forward packets between the hosts 108 of the data center network 100 so as to interconnect traffic between the hosts 108 without those hosts 108 being directly interconnected.

Hosts 108 of the data center network 100 may be servers which provide computing resources for other hosts 108 as well as external hosts on outside networks. These computing resources may include, for example, computer-executable applications, databases, platforms, services, virtual machines, and the like.

The overall architecture of the data center network 100 may be logically organized according to various data center network architectures as known to persons skilled in the art. Examples of data center network architectures include a three-tier architecture (composed of network switches organized into access, aggregate, and core layers), as well as FatTree, BCube, DCell, FiConn, and such newer proposed architectures.

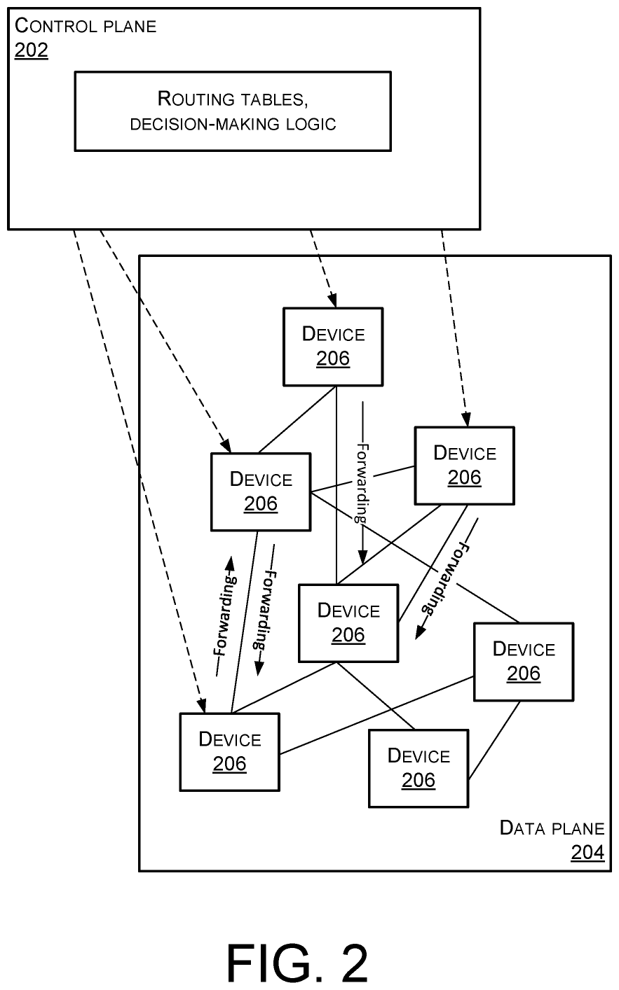

FIG. 2 illustrates a logical diagram of an architecture of the example data center network 100 according to example embodiments of the present disclosure.

The architecture of the data center network 100 may be divided, logically, into at least a control plane 202 and a data plane 204. The control plane 202 is a logical concept describing collective functions of the data center network 100 which determine decision-making logic of data routing in the data center network 100. For example, the control plane 202 includes physical and/or virtual hardware functions of the data center network 100 which record, modify, and propagate routing table information. These physical and/or virtual hardware functions may be distributed among any number of physical and/or virtual network devices of the data center network 100, including switches 106, hosts 108, and other devices having decision-making logic such as routers (not illustrated).

The data plane 204 is a logical concept describing collective functions of the data center network 100 which perform data routing as determined by the above-mentioned decision-making logic. For example, the data plane 204 includes physical and/or virtual hardware functions of the data center network 100 which forward data packets. These physical and/or virtual hardware functions may be distributed among any number of physical and/or virtual network devices of the data center network 100, including switches 106, routers (not illustrated), and other devices having inbound and outbound network interfaces and physical or virtual hardware running computer-executable instructions encoding packet forwarding logic.

Physical and/or virtual network devices 206 of the data plane 204 (described subsequently as “network devices” or “devices” for brevity, though this should be read as including both physical and virtual hardware devices as well as logical combinations of such hardware devices) generally forward data packets according to next-hop forwarding. In next-hop forwarding, physical and/or virtual hardware, such as an ASIC of a switch 106 or computer-executable instructions running on the ASIC, may evaluate, based on routing table information (which may be generated by the control plane), a next-hop forwarding destination of a data packet received on an inbound network interface of a physical or virtual network device 206, such as the switch 106; and may forward the data packet over a network segment to the determined destination over an outbound network interface of the physical or virtual network device 206. It should be understood that devices 206 as illustrated in FIG. 2 do not reside wholly within the data plane 204, but are illustrated therein to facilitate showing examples of forwarding actions which conceptually define the data plane 204. Moreover, similarity in numbering of devices 206 does not indicate homogeneity among those devices 206, such as homogeneity in architecture or ISAs supported, as shall be described subsequently.

Network architectures may be designed to achieve separation of control plane and data plane processing. The separation of control plane and data plane is a concept which describes implementing tasks performed by the control plane 202 and tasks performed by the data plane 204 by different physical or virtual network devices or by different physical or virtual components of those network devices. For example, according to one conceptualization of control plane and data plane separation, decision-making tasks performed in a control plane 202 may be performed by general-purpose processor(s) of physical or virtual network devices, and forwarding tasks performed in a data plane 204 may be performed by special-purpose processor(s) of physical or virtual network devices. This may achieve goals such as increasing network efficiency and throughput by allocating low-computational-intensity tasks to special-purpose processor(s) which have been programmed, by hardware or software design, to perform a limited set of computer-executable instructions representing dedicated tasks which may be limited in terms of size or length, and allocating high-computational-intensity tasks to general-purpose processor(s) which may run a variety of computer-executable instructions of varying size or length.

General-purpose processor(s) and special-purpose processor(s) may be physical hardware processors or virtualized processors. General-purpose processor(s) may generally be high-powered in terms of frequency and may generally provide a generally supported Instruction Set Architecture (“ISA”), such as x86 and the like, enabling them to run computer-executable instructions programmed in a variety of programming languages. Special-purpose processor(s) are more likely to be physical processors such as ASICs, field programmable gate arrays (“FPGAs”), Neural Network Processing Units (“NPUs”), or otherwise accelerator(s) configured to execute particular computer-executable instructions with less computation time than general-purpose processor(s). As a tradeoff, special-purpose processor(s) may be reduced in computational resources, such as memory, functional units such as floating-point units (“FPUs”) and memory management units (“MMUs”), and the like, compared to general-purpose processor(s).

A special-purpose processor may be programmed by writing computer-executable code based on an ISA supported by the special-purpose processor. However, special-purpose processors may support special-purpose ISAs having limited accessibility; for example, access may require proprietary licenses. Moreover, special-purpose processors commonly act as design constraints to the architecture of network devices, as they may have constituent prefabricated core architecture which cannot be modified. Thus, network devices which incorporate certain special-purpose processors generally have processor-specific design architectures, and the architectures of these network devices are likely to be fixed for a particular network device vendor. At the same time, another network device vendor may design network devices incorporating special-purpose processors having different core architectures, rendering ISAs non-interoperable among network devices of different vendors.

Additionally, programming languages suitable for special-purpose processors are traditionally low-level languages, such as hardware description languages. Examples include Verilog and Very High Speed Integrated Circuit Hardware Description Language (“VHDL”). Such languages describe computing logic at the electronic circuit level rather than a higher, more abstract level, and thus generally require expertise in electronic systems design in addition to program skills, raising barrier to entry compared to conventional programming languages.

Furthermore, programming of network devices may be dependent upon logical architecture internal to each network device. For example, a network device such as a switch may be a logical device rather than a singular physical device, designed by interconnecting multiple device elements, such as multiple switching elements in the case of a switch. Multiple device elements making up a logical network device may be organized in logical sequences, such as ordered stages across which network traffic may only flow one by one. Due to the logical flow of traffic across multiple device elements in order, such as stages of switching elements making up a logical switch, portions of computer-executable instructions written for logical network devices may only be executable across device elements in logical order.

As scales of data center networks increase, network devices deployed in these data center networks become increasingly heterogeneous. As the performance of general-purpose processors is increasingly supplemented and enhanced with special-purpose processors, a variety of vendor-specific core architectures, which may further be customized for specific tasks, applications, services, and the like, may be increasingly integrated into the architecture of the data center network, and network devices may increasingly be designed as logical devices having specific logical architectures. Moreover, such special-purpose processors may be deployed in multiple expansions of the hardware specifications and functionality of a data center network. Consequently, in the absence of a common ISA and comparable core architectures for special-purpose processors, network engineers may incur high learning costs to acquire programming knowledge to write code executable across the switch fabric of a data center network, and executable within the fabrics of individual logical network devices, to enforce or support uniform policies and create or maintain customized functionality. The more heterogeneous ISAs and core architectures are represented in the overall data center network architecture, the more training an engineer will need in non-compatible programming skillsets to be able to implement cross-compatible functionality across all ISAs and core architectures. Relatively few engineers generally have backgrounds qualifying them to develop network code for an entire data center.

More recently, programming languages which implement data plane abstractions for ASIC programming have been introduced, such as P4 from Barefoot Networks of Santa Clara, Calif., or NPL from Broadcom of San Jose, Calif. However, these competing languages are generally provisioned for network devices on a per-vendor basis, and each tied to access to proprietary programming tools. Consequently, while learning costs of ASIC programming languages are reduced to some extent compared to those of hardware description languages, vendor-specific learning costs still arises from heterogeneity in network devices deployed in the data center network.

Additionally, compilers may be subject to target-specific compilation constraints. Generally, a compiler target may refer to a particular hardware architecture operative to execute object code output by a compiler. Object code output by a compiler may be executable by one target, but at the same time may not be executable by another target.

Thus, example embodiments of the present disclosure provide a compiler operative to convert computer-executable instructions for a network data plane written in a heterogeneity-agnostic and topology-agnostic programming language into an intermediate representation, then compile the intermediate representation into multiple executable representations according to topological constraints of the network.

Example embodiments of the present disclosure provide a programming language, and may further provide computer-executable instructions which cause a computing system to run a development interface that enables a user to operate the computing system to write source code in accordance with syntax of the programming language, debug the source code, and compile the source code by executing a compiler according to example embodiments of the present disclosure.

The development interface executed by the computing system may be, for example, an integrated development environment (“IDE”), which provides functional components such as a source code editor, a build automation interface, a version control system, class and object browsers, a compiler interface, and further such functions as known to persons skilled in the art of software development.

A programming language according to example embodiments of the present disclosure may provide a syntax wherein functions of a data center network data plane are represented as heterogeneity-agnostic and topology-agnostic abstractions (described subsequently as “agnostic abstractions” for brevity). Heterogeneity-agnosticism and topology-agnosticism according to example embodiments of the present disclosure may refer to abstractions of the programming language being agnostic as to heterogeneity in network devices of a data plane 204 of the data center network 100 and architectures and network communication protocols thereof, as well as being agnostic as to topology of network interconnections therebetween.

For example, the programming language may refer to data packets in terms of contents of packet headers, but may not refer to protocol-specific aspects of those packet headers, such as field names, field lengths, or field syntaxes. Packet headers according to an agnostic abstraction of the programming language may, or may not, be homologous to packet headers according to particular protocols. For example, packet headers according to an agnostic abstraction of the programming language may, or may not, correspond one-to-one to packet headers of particular protocols. Packet headers according to an agnostic abstraction of the programming language may not define fields corresponding to all fields of packet headers of particular protocols; may define fields corresponding to fields of packet headers of some protocols but not other protocols; may define multiple fields corresponding to a same field of a packet header of a particular protocol; may define one field corresponding to multiple fields of a packet header of a particular protocol; and so on.

For example, the programming language may refer to packet handling actions which may be performed by network devices of a data plane 204 upon data packets, such as encapsulation and decapsulation of the packets; adding, modifying, and/or deleting single-protocol fields of packet headers such as address information, flags, parameters, and the like; and adding, modifying, and/or deleting inter-protocol fields of packet headers such as path and addressing information as specified by MPLS. Packet handling actions according to an agnostic abstraction of the programming language may, or may not, be homologous to packet handling actions according to particular protocols. For example, packet handling actions according to an agnostic abstraction of the programming language may, or may not, correspond one-to-one to packet handling actions of particular protocols. Packet handling actions according to an agnostic abstraction of the programming language may not correspond to all packet handling actions of particular protocols, and may correspond to packet handling actions of some protocols but not other protocols. Multiple packet handling actions according to an agnostic abstraction of the programming language may correspond to one packet handling action of a particular protocol. One packet handling action according to an agnostic abstraction of the programming language may correspond to multiple packet handling actions of a particular protocol.

Moreover, protocols as described herein may be protocols defined at a circuit level of network devices of the data plane 204. For example, protocols as described herein may be IP, TCP, VxLAN, MPLS, and the like. Protocols as described herein may also be protocols defined by an abstraction of another programming language defined over data plane circuit-level protocols (described subsequently as “intermediate abstractions” for brevity). For example, protocols as described herein may be abstraction protocols defined according to P4, NPL, and the like. Consequently, correspondences between aspects of protocols, such as headers and handling actions, may run from agnostic abstractions of the programming language according to example embodiments of the present disclosure, to intermediate abstractions of another programming language, to headers and handling actions of one or more circuit-level protocols. These correspondences may be non-homologous with respect to aspects of the intermediate abstraction and/or aspects of the circuit-level protocols in any matter as described above.

Users of a computing system running a development interface as described above may write source code to be executed by network devices of the data plane 204, so as to customize parsing, encapsulation, forwarding, and otherwise handling of data packets by network device functions making up the data plane. For example, users may write source code describing computer-executable instructions which govern multicore processing of network devices of the data plane 204; load balancing of network devices of the data plane 204; packet queuing in network devices of the data plane 204; scheduling in network devices of the data plane 204; and other such behaviors of network devices of the data plane 204. Such computer-executable instructions may improve the efficiency of network devices of the data plane 204 in forwarding traffic over the data center network 100 based on network traffic conditions, including volume, types, bandwidth, quotas, source and destination addresses and geographic regions, peak times, and the like. Those users may then execute a compiler running on the computing system according to example embodiments of the present invention, causing the source code to be compiled into object code executable by network devices of the data plane 204 of the data center network 100.

Due to the logically defined functionality of a data plane 204, as described by agnostic abstractions of the programming language, being distributed over many network devices, a compiler according to example embodiments of the present disclosure may target a variety of heterogeneous network devices in compiling source code. However, target-specific compilation may suffer from compilation constraints, as described above.

Thus, a compiler according to example embodiments of the present disclosure may provide an intermediate conversion module which receives source code as input and converts control flow of the source code into an intermediate representation thereof. A compiler according to example embodiments of the present disclosure further provides a multiple code generation module which compiles the intermediate representation of the source code into multiple object code outputs respectively executable by different hardware architectures.

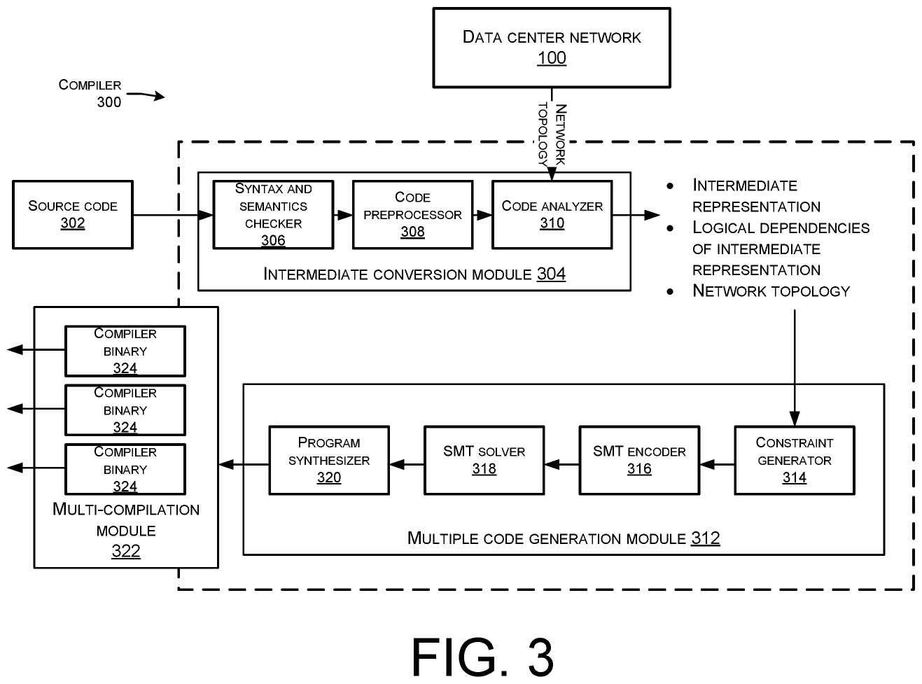

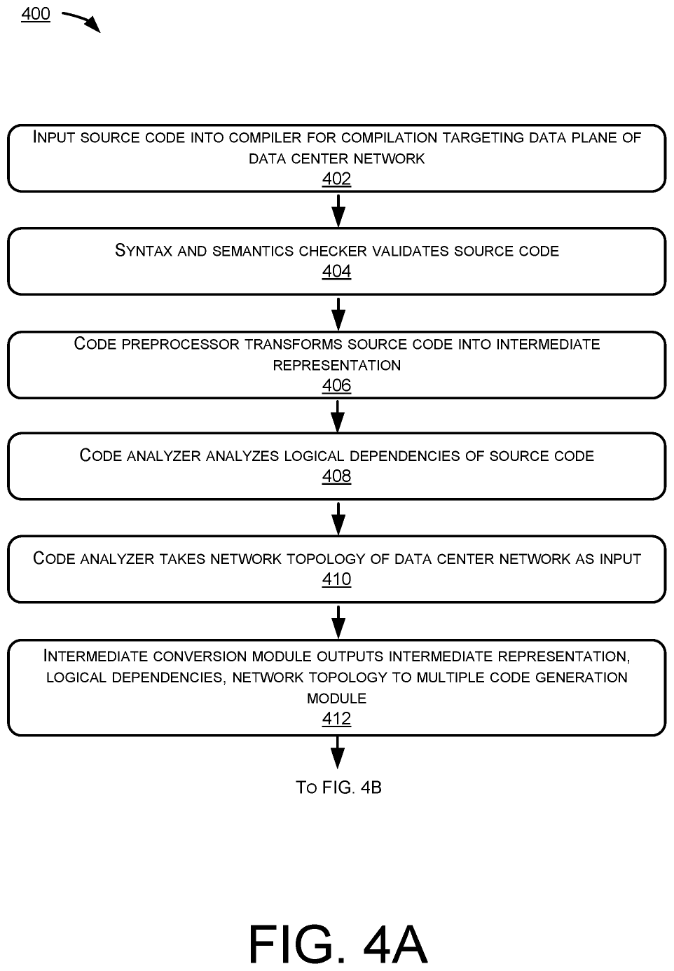

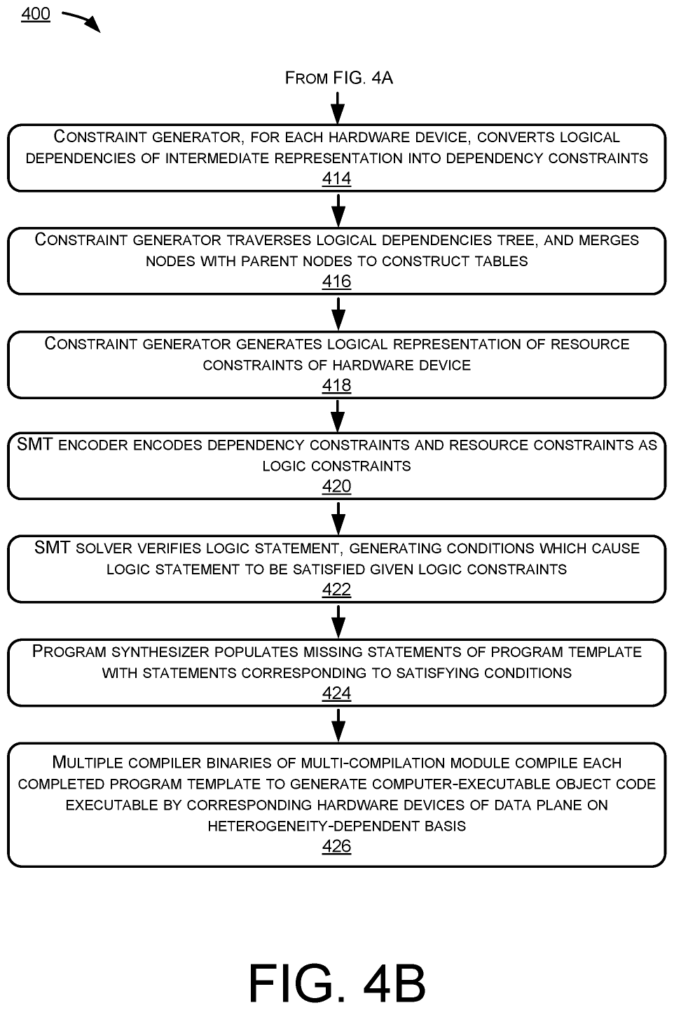

FIG. 3 illustrates a schematic architecture of a compiler 300 according to example embodiments of the present disclosure. In parallel, FIGS. 4A and 4B illustrate a flowchart of a compilation method 400 according to example embodiments of the present disclosure. According to example embodiments of the present disclosure, the compiler 300 may be operative to compile heterogeneity-agnostic and topology-agnostic source code into object code outputs executable by multiple hardware architectures.

Source code 302, as illustrated, may be generated by a user operating a computing system to input source code. The computing system may further be running a development interface as described above to facilitate coding, debugging, and compilation.

At a step 402, source code 302 is input into the compiler 300 for compilation targeting a data plane 204 of a data center network 100 as described above. From a perspective of a user, the data center network 100 may be a singular compilation target. Thus, while the compiler 300 may ultimately compile for multiple compilation targets, such as heterogeneous network devices of a data center network 100 as described herein, the heterogeneity of compilation targets may be hidden from the user operating the computing system. For example, the heterogeneity of compilation targets may be disregarded according to agnostic abstractions of the programming language of the source code, as described above, even if certain functions described in the source code may only be executed by some of the heterogeneous network devices and not others.

Upon being input into the compiler 300, the source code 302 may be received by an intermediate conversion module 304. The intermediate conversion module 304 may include submodules such as a syntax and semantics checker 306 and a code preprocessor 308 as known to persons skilled in the art; for example, at a step 404, a syntax and semantics checker 306 validates the source code 302. The syntax and semantics checker 306 may determine whether the source code 302 contains errors with regard to syntax and semantics of the programming language described herein, and may terminate compilation and return errors to the user where necessary. At a step 406, a code preprocessor 308 transforms the source code 302 into an intermediate representation thereof. For example, the code preprocessor 308 may standardize tokens and characters thereof for subsequent compilation.

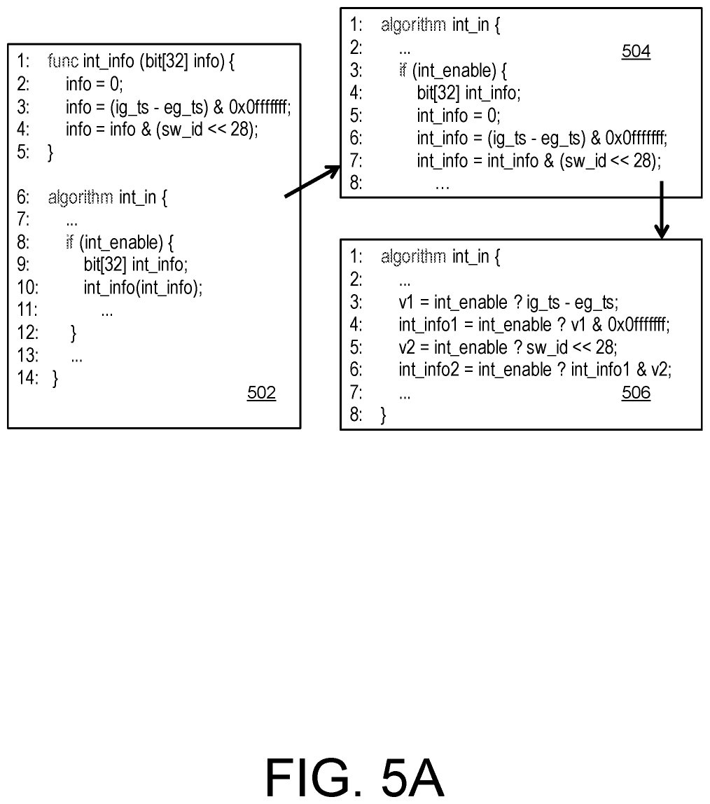

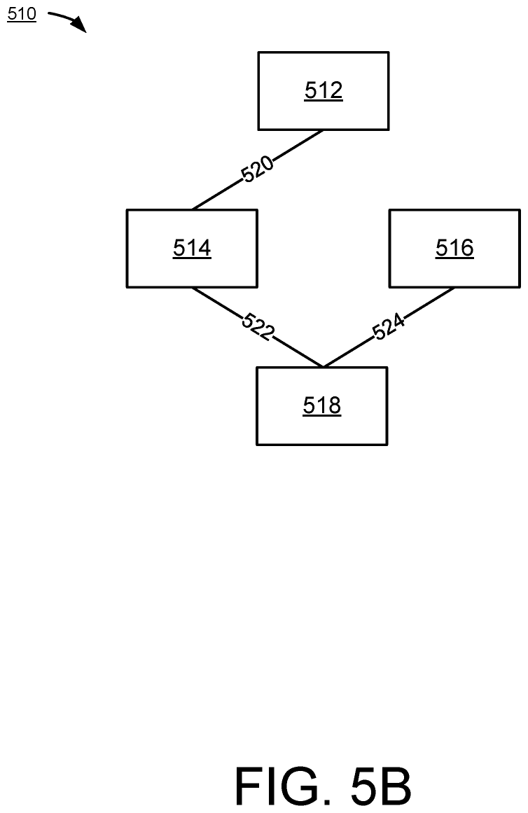

Furthermore, according to example embodiments of the present disclosure, the code preprocessor 308 performs linearization upon the source code 302. This may be performed by converting all conditionally executed code among the source code 302 into unconditionally executed code. FIG. 5A illustrates a flowchart illustrating code linearization according to example embodiments of the present disclosure, using a sample excerpt of code for illustration.

For example, any function other than a main function of the source code 302, or otherwise any function which is not sequentially executed after an entry point of executing the source code 302, may be conditionally executed code; it may be transformed into unconditionally executed code by rewriting code within the function as part of the main function or in sequential execution order after the entry point, substituting all arguments of the function into the code of the function itself.

For example, any conditional statement of the source code 302 may be conditionally executed code; it may be transformed into unconditionally executed code by extracting each line of code from within the conditional statement, then rewriting the conditional statement to be individually evaluated within each extracted line of code.

For example, any conditional statement of the source code 302 which has two or more branches may be conditionally executed code; it may be transformed into unconditionally executed code by extracting each line of code from within each branch of the conditional statement, then rewriting each conditional statement to be individually evaluated within each statement among the lines of code extracted therefrom.

For example, any loop statement of the source code 302 may be conditionally executed code; it may be transformed into unconditionally executed code by copying each line of code within the loop statement some number of times according to conditions of the loop statement, and placing these copies in sequential execution order to each other.

Other conditionally executed constructs of the source code 302 may be transformed into unconditionally executed code in similar manners. Overall, linearization of the source code 302 may be performed in an inside-out order, starting from a most deeply nested level among statements of the source code 302 and working outward.

As FIG. 5A illustrates, starting from input source code 502 as written by a user, the code preprocessor 308 may determine that the object “int_in” of class “algorithm” is a main function or is an entry point of the input source code 502, in accordance with definitions of the class “algorithm” as may be defined by syntax of a programming language according to example embodiments of the present disclosure. Following each line of code in sequential execution order, the code preprocessor 308 may determine that the block of code starting with “if(int_enable)” is a conditional statement. Within the conditional statement, the code preprocessor 308 may further determine that the block of code starting with “int_info(int_info)” is a call to the function “int_info( )” declared earlier in the input source code 502. Other portions of the input source code 502 have been omitted for brevity.

Consequently, after linearizing any further conditionally executed code blocks nested within the block of code starting with “int_info(int_info)” (if any), and before linearizing any blocks of code that the block of code starting with “if(int_enable)” is nested within (if any), the code preprocessor 308 may first rewrite the function “int_info( )” as declared earlier in the input source code 502 in its execution order where it was originally called in the illustrated block of code, with the argument “int_info” substituted into the body of the function replacing the variable “info,” resulting in the first state 504 as illustrated.

Then, the code preprocessor 308 may rewrite the conditional statement starting with “if(int_enable)” by rewriting the conditional statement to be individually evaluated within each statement within the lines of code therein. Consequently, the statements previously taken from “int_info( )” now each evaluate the conditional statement “if(int_enable),” and furthermore some of these statements have been broken up into multiple lines wherein each constituent statement therein is individually evaluated, as illustrated by the second state 506 as illustrated.

Assuming the conditional statement “if(int_enable)” was not nested within any other conditionally executed blocks of code, the code as illustrated by the second state 506 may represent how this code will appear in an intermediate representation which will be output by the intermediate conversion module 304. However, the intermediate conversion module 304 may not yet output the intermediate representation until a code analyzer 310 has further evaluated the code.

According to example embodiments of the present disclosure, the intermediate conversion module 304 may further include a code analyzer 310. At a step 408, the code analyzer 310 analyzes logical dependencies of the source code 302. Logical dependencies may refer to how sections of code depend on execution of other code in their execution logic. A line of code or multiple consecutive lines of code which all logically depend upon execution of some lines of code elsewhere may be considered as a unit with regard to the dependency analysis; the nature of a line or lines as a unit may be determined based on variables found within the line or lines of code standing alone, without necessarily having yet determined which exact line(s) of code, and the exact nature of the line(s) of code, which the unit logically depends upon. Moreover, the logical dependency may be upon more than one line(s) of code each independently providing a condition upon which the unit depends upon.

For example, as illustrated in the second state 506 of FIG. 5A, line 3 makes up a first unit having logical dependency upon some one or more line(s) of code (not illustrated herein) which generate(s) values of the variables “int_enable,” “ig_ts” and “eg_ts”; line 4 makes up a second unit having logical dependency upon one or more line(s) of code (not illustrated herein) which generate(s) a value of the variable “int_enable,” and having logical dependency upon the first unit by virtue of line 3 generating a value of the variable “v1”; line 5 makes up a third unit having logical dependency upon some one or more line(s) of code (not illustrated herein) which generate(s) values of the variables “int_enable” and “sw_id”; and line 6 makes up a fourth unit having logical dependency upon some one or more line(s) of code (not illustrated herein) which generate(s) a value of the variable “int_enable,” and having logical dependency upon the second unit by virtue of line 4 generating a value of the variable “int_info1,” and having logical dependency upon the third unit by virtue of line 5 generating a value of the variable “v2.” This analysis assumes that no other lines of code pertaining to the above-identified variables precede or follow lines 3 to 6.

At a step 410, the code analyzer 310, in addition to the source code 302, further takes a network topology of the data center network 100 as input. The network topology may be determined by the data center network 100 internally and forwarded to the code analyzer 310. The network topology may describe each network device making up the data plane 204, and may describe interconnectivity of each of these network devices. For example, given ten particular physical or virtual switches of a data center network 100 (without limitation of the data center network 100 to ten switches in a switch fabric 104), a first set of five switches arbitrarily numbered 1 to 5 and a second set of five switches arbitrarily numbered 6 to 10 may have, respectively, heterogeneous architectures from each other. Moreover, some of these switches may be interconnected by network segments, while others are not interconnected.

Thus, the network topology may include dependencies of network devices of the data plane 204 based on network segment interconnections therebetween, as well as dependencies of network devices upon hardware architectures (and thus ISAs) of those network devices.

Subsequent to the operation of the code analyzer 310, at a step 412, the intermediate conversion module 304 outputs the intermediate representation, the logical dependencies of the intermediate representation, and the network topology to a multiple code generation module 312. The multiple code generation module 312 passes the intermediate representation, the logical dependencies thereof, and the network topology to a constraint generator 314.

The constraint generator 314 may traverse each network device of the data plane 204 in accordance with the network topology. At a step 414, the constraint generator 314, for each network device, converts logical dependencies of the intermediate representation into dependency constraints. The dependency constraints may further reflect how the code will run on that network device, including whether each individual line of code will run on the network device; which logical elements of the network device may, or may not, run which individual lines of code; logical sequences of whether one line of code must be executed before another line of code; and further consequences of interactions between the above-mentioned dependency constraints and the like, without limitation thereto. Thus, the conversion of logical dependencies into dependency constraints may further be tailored to each individual network device.

For each network device, the constraint generator 314 may construct a tree structure organizing logical dependencies of intermediate representation code to be run on that network device, wherein a unit having logical dependency upon some line(s) of code may be represented as a node connected (by an edge) to a parent node representing the line(s) of code. Some nodes may be orphan nodes which are not connected to any parent node. From the leaf nodes to the root, nodes having the same depth along the height of the tree may be organized into a layer.

For example, FIG. 5B illustrates a partial tree 510 including nodes and edges as constructed based on the second state 506 of FIG. 5A, according to the above example of step 408: the first unit is represented by node 512, the second unit is represented by node 514, the third unit is represented by node 516, and the fourth unit is represented by node 518. A first edge 520 connects node 514 to node 512 as its parent. A second edge 522 connects node 518 to node 514 as its parent. A third edge 526 connects node 518 to node 516 as its parent. Other nodes which may connect these nodes to other nodes of the partial tree 510 are not illustrated herein.

Next, at a step 416, the constraint generator 314 traverses a logical dependencies tree constructed for a network device, and merges nodes with parent nodes to construct tables. For example, the constraint generator 314 may travel upward from each lowest leaf node of the tree; upon traversing each edge of the tree to a parent node, the dependent node is merged with the parent node in a table. Furthermore, in the event that nodes of a layer make up mutually exclusive branches of a conditional statement, such as an if-else statement or a switch-case statement, each node of the layer may be merged into a same table. Upon finding no more nodes which may be merged with a parent node, this step may be completed. This step may output a set of tables which logically represents dependency constraints of the intermediate representation of the source code 302.

Additionally, in addition to dependency constraints of the intermediate representation to be run on the network device, at a step 418, the constraint generator 314 further generates a logical representation of resource constraints of the network device. The logical representation may take the form of a knowledge base of a standardized format. The logical representation may include information such as hardware architecture of the network device; ISA(s) and/or data plane abstraction programming languages supported by the network device, and support thereof, or lack of support thereof, for particular high-level functions provided by agnostic abstractions of the programming language according to example embodiments of the present disclosure; network segment connections of the network device to other network devices; logical orders between packet handling actions (for example, ingress of a packet at the network device must logically precede egress of the packet from the network device); minimum packet latency of the network device (i.e., time required for packet egress minus time required for packet ingress); and the like. Generally, each of these resource constraints may limit whether particular computer-executable instructions of the intermediate representation of the source code 302 may actually be executed on a particular switch, thus exposing heterogeneity-based and topology-based dependencies which were hidden from the user at the programming language level.

To illustrate resource constraints with regard to one possible logical architecture of a network device, suppose that a logical network device (referred to as “switch A” for the purpose of this example) is a three-stage switch established by interconnecting a fabric architecture of three stages of switching elements, such as individual hardware switches; switches of a first stage only receive inbound packets into the fabric and forward packets to switches of a second stage; switches of the second stage only receive packets from switches of the first stage and forward packets to switches of a third stage; and switches of the third stage only receive packets forwarded from switches of the second stage and forward packets outbound from the fabric. Each stage of the fabric architecture hosts only one routing table. Thus, normally, ingress of packets takes place at the first stage, and egress of packets takes place at the third stage; determination of ingress time may be executable at the first stage or later (at any switching element) and determination of egress time may be executable at the third stage or earlier, but determination of egress time must be executed after determination of ingress time.

Next, the constraint generator 314 forwards the dependency constraints and the resource constraints to a SMT encoder 316.

According to satisfiability modulo theories (“SMT”), given an incomplete logical formula and constraints on a solution to the formula, a SMT solver may verify that the solution may be satisfied by the constraints, and, in the process, generate conditions which cause the solution to be satisfied. Thus, at a step 420, the SMT encoder 316 encodes the dependency constraints and the resource constraints as logic constraints. The logic constraints may be first-order logic statements as required for the operation of a SMT solver. A first-order logic statement according to example embodiments of the present disclosure may correspond to a program template, which may be a pre-written set of computer-executable instructions for a particular hardware description language or data plane abstraction language supported by a particular network device in a heterogeneity-dependent and topology-dependent manner, missing certain statements corresponding to possible conditions which may satisfy the logic statements, given certain constraints such as dependency constraints and resource constraints as described above. Examples of forms of the first-order logic statements may include, for example, functions defining equalities wherein certain terms are undetermined.

For example, a program template for a set of computer-executable instructions which compute latency of each packet forwarded through switch A may be defined as a first-order logic statement as follows.

Switch A's hardware architecture supports returning packet ingress time by a call to ingress_time( ), supports returning packet egress time by a call to egress_time( ), and supports setting a field of a packet header by a call to set_field( ). The egress time for a packet must follow the packet's ingress, so egress_time( ) should normally only be called in the program template after ingress_time( ) is called for the same packet. However, set_field( ) may be called at any time for any given field of the packet header (for example, set_field(IPv4, 1) may be called to set an IPv4 address field of a packet header to a value of 1) without limitation as to order relative to ingress_time( ) or egress_time( ). Thus, we have a first-order formula: (ingress_stage<egress_stage)\hat{ }(1<=ingress_stage<=3)\hat{ }(1<=egress_stage<=3)\hat{ }(1<=set_filed<=3)\hat{ }(egress_stage+ingress_stage+set_filed<=6), where \hat{ } means conjunction. We can observe the dependency between ingress_time( ) and egress_time( ) is encoded as a constraint ingress_stage<egress_stage.

Next, the SMT encoder 316 forwards the encoded logic constraints to a SMT solver 318. A SMT solver 318 refers to an engine operative to verify a logic statement based on the encoded logic constraints, and generate satisfying conditions in the process. Known SMT solvers to persons skilled in the art include, for example, Z3 Theorem Prover from Microsoft Corporation of Redmond, Wash.

At a step 422, the SMT solver 318 verifies the logic statement, generating conditions which cause the logic statement to be satisfied given the encoded logic constraints.

Next, the SMT solver 318 outputs the satisfying conditions to a program synthesizer 320. In the above example, by solving the formula, we can get ingress_time( ) must be implemented as a table at any switching element of the first stage, egress_time( ) and set_filed(IPv4, 1) could be implemented as tables, respectively, placed at any switching element either in stage 2 or stage 3. A program synthesizer 320 according to example embodiments of the present disclosure may include a program template as described above. Based on ISAs supported by a particular network device, data plane abstraction languages supported by a particular network device, and the like, heterogeneity-dependent and topology-dependent program templates as described above may be completed. At a step 424, the program synthesizer 320 populates statements of the program templates with statements corresponding to the satisfying conditions output by the SMT solver 318.

The above-mentioned steps performed by the compiler 300 may then be repeated for each network device of the data plane 204.

Finally, the program synthesizer 320 may pass each completed program template for each network device of the data plane 204 to a multi-compilation module 322. The multi-compilation module 322 may include multiple computer-executable compiler binaries 324 corresponding to each of multiple hardware description languages and/or data plane abstraction languages supported by different network devices of the data plane 204 on a heterogeneity-dependent basis. At a step 426, multiple compiler binaries 324 of the multi-compilation module 322 compile each completed program template to generate computer-executable object code executable by corresponding network devices of the data plane 204 on a heterogeneity-dependent basis.

Thus, by the above-described compiler and method, users may develop software-defined network functionality for a data center network composed of heterogeneous network devices by writing code in a programming language implementing heterogeneity-agnostic and topology-agnostic abstractions, while the compiler synthesizes heterogeneity-dependent and topology-dependent computer-executable object code implementing the software-defined network functionality across network devices of the data center network by analyzing logical dependencies and network topology to determine dependency constraints and resource constraints.

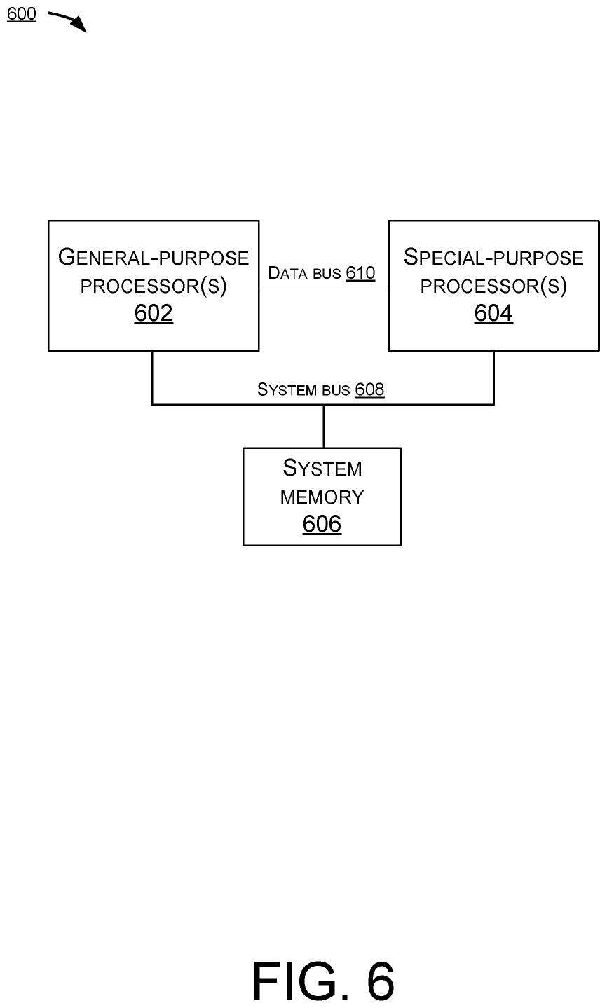

FIG. 6 illustrates a system architecture of a network hardware system 600 according to example embodiments of the present disclosure.

A network hardware system 600 according to example embodiments of the present disclosure may include one or more general-purpose processor(s) 602 and one or more special-purpose processor(s) 604. The general-purpose processor(s) 602 and special-purpose processor(s) 604 may be physical or may be virtualized and/or distributed. The general-purpose processor(s) 602 and special-purpose processor(s) 604 may execute one or more instructions stored on a computer-readable storage medium as described below to cause the general-purpose processor(s) 602 or special-purpose processor(s) 604 to perform control plane 202 and data plane 204 functions. Special-purpose processor(s) 604 may be computing devices having hardware or software elements facilitating computation of data plane tasks, such as packet-handling functions. For example, special-purpose processor(s) 604 may be accelerator(s), such as Neural Network Processing Units (“NPUs”), implementations using field programmable gate arrays (“FPGAs”) and application specific integrated circuits (“ASICs”), and/or the like. To facilitate computation of tasks such as matrix multiplication, special-purpose processor(s) 604 may, for example, implement circuits operative to process network communication protocols.

A system 600 may further include a system memory 606 communicatively coupled to the general-purpose processor(s) 602 and the special-purpose processor(s) 604 by a system bus 608. The system memory 606 may be physical or may be virtualized and/or distributed. Depending on the exact configuration and type of the system 600, the system memory 606 may be volatile, such as RAM, non-volatile, such as ROM, flash memory, miniature hard drive, memory card, and the like, or some combination thereof.

The system bus 608 may transport data between the general-purpose processor(s) 602 and the system memory 606, between the special-purpose processor(s) 604 and the system memory 606, and between the general-purpose processor(s) 502 and the special-purpose processor(s) 604. Furthermore, a data bus 610 may transport data between the general-purpose processor(s) 602 and the special-purpose processor(s) 604. The data bus 610 may, for example, be a Peripheral Component Interconnect Express (“PCIe”) connection, and the like.

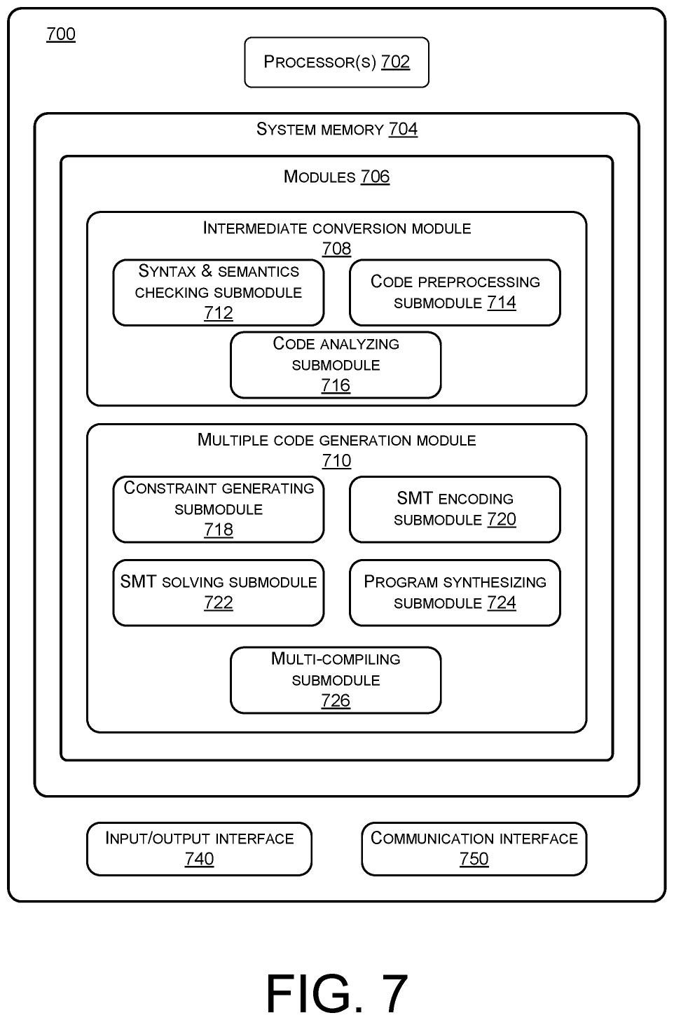

FIG. 7 illustrates an example computing system 700 for implementing the processes and methods described above for implementing compilation.

The techniques and mechanisms described herein may be implemented by multiple instances of the computing system 700, as well as by any other computing device, system, and/or environment. The computing system 700 may be any varieties of computing devices, such as personal computers, personal tablets, mobile devices, other such computing devices operative to perform matrix arithmetic computations. The computing system 700 shown in FIG. 7 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 700 may include one or more processors 702 and system memory 704 communicatively coupled to the processor(s) 702. The processor(s) 702 and system memory 704 may be physical or may be virtualized and/or distributed. The processor(s) 702 may execute one or more modules and/or processes to cause the processor(s) 702 to perform a variety of functions. In embodiments, the processor(s) 702 may include a central processing unit (“CPU”), a graphics processing unit (“GPU”), an NPU, any combinations thereof, or other processing units or components known in the art. Additionally, each of the processor(s) 702 may possess its own local memory, which also may store program modules, program data, and/or one or more operating systems.

Depending on the exact configuration and type of the computing system 700, the system memory 704 may be volatile, such as RAM, non-volatile, such as ROM, flash memory, miniature hard drive, memory card, and the like, or some combination thereof. The system memory 704 may include one or more computer-executable modules 706 that are executable by the processor(s) 702.

The modules 706 may include, but are not limited to, an intermediate conversion module 708 and a multiple code generation module 710. The intermediate conversion module 708 may further include a syntax and semantics checking submodule 712, a code preprocessing submodule 714, and a code analyzing submodule 716. The multiple code generation module 710 may further include a constraint generating submodule 718, a SMT encoding submodule 720, a SMT solving submodule 722, a program synthesizing submodule 724, and a multi-compiling submodule 726.

The syntax and semantics checking submodule 712 may be configured to perform functionality of the syntax and semantics checker 306 as described above.

The code preprocessing submodule 714 may be configured to perform functionality of the code preprocessor 308 as described above.

The code analyzing submodule 716 may be configured to perform functionality of the code analyzer 310 as described above with reference to step 206.

The constraint generating submodule 718 may be configured to perform functionality of a constraint generator 314 as described above.

The SMT encoding submodule 720 may be configured to perform functionality of a SMT encoder 316 as described above.

The SMT solving submodule 722 may be configured to perform functionality of a SMT solver 318 as described above.

The program synthesizing submodule 724 may be configured to perform functionality of a program synthesizer 320 as described above.

The multi-compiling module 726 may be configured to perform functionality of a multi-compilation module 322 as described above.

The system 700 may additionally include an input/output (“I/O”) interface 740 and a communication module 750 allowing the system 700 to communicate with other systems and devices over a network, such as server host(s) as described above. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RANI”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides a compiler operative to convert computer-executable instructions for a network data plane written in a heterogeneity-agnostic and topology-agnostic programming language into an intermediate representation, then compile the intermediate representation into multiple executable representations according to topological constraints of the network. Users may develop software-defined network functionality for a data center network composed of heterogeneous network devices by writing code in a programming language implementing heterogeneity-agnostic and topology-agnostic abstractions, while the compiler synthesizes heterogeneity-dependent and topology-dependent computer-executable object code implementing the software-defined network functionality across network devices of the data center network by analyzing logical dependencies and network topology to determine dependency constraints and resource constraints.

### Example Clauses

A. A method comprising: analyzing logical dependencies of an intermediate representation of a source code, the source code being input into a compiler targeting a plurality of heterogeneous network devices; converting, for at least one network device of the plurality of heterogeneous network devices, logical dependencies of the intermediate representation into dependency constraints; encoding the dependency constraints as logic constraints; and generating conditions which cause a logic statement to be satisfied given the encoded logic constraints.

B. The method as paragraph A recites, further comprising linearizing the source code to generate the intermediate representation.

C. The method as paragraph A recites, wherein converting logical dependencies of the intermediate representation into dependency constraints comprises constructing a tree structure organizing the logical dependencies.

D. The method as paragraph A recites, further comprising generating a logical representation of resource constraints of the network device.

E. The method as paragraph D recites, wherein the encoded logic constraints further comprise the resource constraints.

F. The method as paragraph A recites, further comprising populating missing statements of a program template with statements corresponding to the satisfying conditions.

G. The method as paragraph F recites, further comprising compiling the program template to generate a heterogeneity-dependent computer-executable object code executable by a network device of the plurality of heterogeneous network devices.

H. A system comprising: one or more processors; and memory communicatively coupled to the one or more processors, the memory storing computer-executable modules executable by the one or more processors that, when executed by the one or more processors, perform associated operations, the computer-executable modules comprising: an intermediate conversion module further comprising a code analyzing module configured to analyze logical dependencies of an intermediate representation of a source code, the source code being input into a compiler targeting a plurality of heterogeneous network devices; and a multiple code generation module further comprising: a constraint generating submodule configured to convert, for at least one network device of the plurality of heterogeneous network devices, logical dependencies of the intermediate representation into dependency constraints; a SMT encoding submodule configured to encode logic constraints comprising the dependency constraints; and a SMT solving submodule configured to generate conditions which cause a logic statement to be satisfied given the encoded logic constraints.

I. The system as paragraph H recites, wherein the intermediate conversion module further comprises a code preprocessing submodule configured to linearize the source code to generate the intermediate representation.

J. The system as paragraph H recites, wherein the constraint generating submodule is configured to convert logical dependencies of the intermediate representation into dependency constraints by constructing a tree structure organizing the logical dependencies.

K. The system as paragraph H recites, wherein the constraint generating submodule is further configured to generate a logical representation of resource constraints of the network device.

L. The system as paragraph K recites, wherein the encoded logic constraints further comprise the resource constraints.

M. The system as paragraph H recites, wherein the multiple code generation module further comprises a program synthesizing submodule configured to populate missing statements of a program template with statements corresponding to the satisfying conditions.

N. The system as paragraph M recites, wherein the multiple code generation module further comprises a multi-compiling submodule configured to compile the program template to generate a heterogeneity-dependent computer-executable object code executable by a network device of the plurality of heterogeneous network devices.

O. A computer-readable storage medium storing computer-readable instructions executable by one or more processors, that when executed by the one or more processors, cause the one or more processors to perform operations comprising: analyzing logical dependencies of an intermediate representation of a source code, the source code being input into a compiler targeting a plurality of heterogeneous network devices; converting, for at least one network device of the plurality of heterogeneous network devices, logical dependencies of the intermediate representation into dependency constraints; encoding the dependency constraints as logic constraints; and generating conditions which cause a logic statement to be satisfied given the encoded logic constraints.

P. The computer-readable storage medium as paragraph O recites, wherein the operations further comprise linearizing the source code to generate the intermediate representation.

Q. The computer-readable storage medium as paragraph O recites, wherein converting logical dependencies of the intermediate representation into dependency constraints comprises constructing a tree structure organizing the logical dependencies.

R. The computer-readable storage medium as paragraph O recites, wherein the operations further comprise generating a logical representation of resource constraints of the network device.

S. The computer-readable storage medium as paragraph R recites, wherein the encoded logic constraints further comprise the resource constraints.

T. The computer-readable storage medium as paragraph O recites, wherein the operations further comprise populating missing statements of a program template with statements corresponding to the satisfying conditions.

U. The computer-readable storage medium as paragraph T recites, wherein the operations further comprise compiling the program template to generate a heterogeneity-dependent computer-executable object code executable by a network device of the plurality of heterogeneous network devices.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method comprising:
analyzing logical dependencies of an intermediate representation of a source code, the source code being input into a compiler targeting a plurality of heterogeneous network devices;
converting, for at least one network device of the plurality of heterogeneous network devices, logical dependencies of the intermediate representation into dependency constraints;
encoding logic constraints comprising the dependency constraints; and
generating conditions which cause a logic statement to be satisfied given the encoded logic constraints.

2. The method of claim 1, further comprising linearizing the source code to generate the intermediate representation.

3. The method of claim 1, wherein converting logical dependencies of the intermediate representation into dependency constraints comprises constructing a tree structure organizing the logical dependencies.

4. The method of claim 1, further comprising generating a logical representation of resource constraints of the network device.

5. The method of claim 4, wherein the encoded logic constraints further comprise the resource constraints.

6. The method of claim 1, further comprising populating missing statements of a program template with statements corresponding to the satisfying conditions.

7. The method of claim 6, further comprising compiling the program template to generate a heterogeneity-dependent computer-executable object code executable by a network device of the plurality of heterogeneous network devices.

8. A system comprising:
one or more processors; and
memory communicatively coupled to the one or more processors, the memory storing computer-executable modules executable by the one or more processors that, when executed by the one or more processors, perform associated operations, the computer-executable modules comprising:
an intermediate conversion module further comprising a code analyzing module configured to analyze logical dependencies of an intermediate representation of a source code, the source code being input into a compiler targeting a plurality of heterogeneous network devices; and
a multiple code generation module further comprising:
a constraint generating submodule configured to convert, for at least one network device of the plurality of heterogeneous network devices, logical dependencies of the intermediate representation into dependency constraints;
a satisfiability modulo theories (SMT) encoding submodule configured to encode logic constraints comprising the dependency constraints; and
an SMT solving submodule configured to generate conditions which cause a logic statement to be satisfied given the encoded logic constraints.

9. The system of claim 8, wherein the intermediate conversion module further comprises a code preprocessing submodule configured to linearize the source code to generate the intermediate representation.

10. The system of claim 8, wherein the constraint generating submodule is configured to convert logical dependencies of the intermediate representation into dependency constraints by constructing a tree structure organizing the logical dependencies.

11. The system of claim 8, wherein the constraint generating submodule is further configured to generate a logical representation of resource constraints of the network device.

12. The system of claim 11, wherein the encoded logic constraints further comprise the resource constraints.

13. The system of claim 8, wherein the multiple code generation module further comprises a program synthesizing submodule configured to populate missing statements of a program template with statements corresponding to the satisfying conditions.

14. The system of claim 13, wherein the multiple code generation module further comprises a multi-compiling submodule configured to compile the program template to generate a heterogeneity-dependent computer-executable object code executable by a network device of the plurality of heterogeneous network devices.

15. A computer-readable storage medium storing computer-readable instructions executable by one or more processors, that when executed by the one or more processors, cause the one or more processors to perform operations comprising:
analyzing logical dependencies of an intermediate representation of a source code, the source code being input into a compiler targeting a plurality of heterogeneous network devices;
converting, for at least one network device of the plurality of heterogeneous network devices, logical dependencies of the intermediate representation into dependency constraints;
encoding logic constraints comprising the dependency constraints; and
generating conditions which cause a logic statement to be satisfied given the encoded logic constraints.

16. The computer-readable storage medium of claim 15, wherein the operations further comprise linearizing the source code to generate the intermediate representation.

17. The computer-readable storage medium of claim 15, wherein converting logical dependencies of the intermediate representation into dependency constraints comprises constructing a tree structure organizing the logical dependencies.

18. The computer-readable storage medium of claim 15, wherein the operations further comprise generating a logical representation of resource constraints of the network device.

19. The computer-readable storage medium of claim 18, wherein the encoded logic constraints further comprise the resource constraints.

20. The computer-readable storage medium of claim 15, wherein the operations further comprise populating missing statements of a program template with statements corresponding to the satisfying conditions.
